(19) United States
(12) Patent Application Publication
(10) Pub. No.: US 2023/0366751 A1
(43) Pub. Date: Nov. 16, 2023

(54) TEMPERATURE INDICATOR

(71) Applicant: ShockWatch, Inc, Dallas, TX (US)

(72) Inventors: Johannes van Niekerk, Dallas, TX (US); Chris Chapman, Exmouth (GB); Mark Brady, Deeside (GB); Toby William Armstrong, Heswall (GB)

(21) Appl. No.: 18/315,624

(22) Filed: May 11, 2023

Related U.S. Application Data
(60) Provisional application No. 63/449,860, filed on Mar. 3, 2023.
(60) Provisional application No. 63/341,673, filed on May 13, 2022.

(51) Int. Cl. G01K 11/06; G01K 11/12; G06K 19/06

(52) U.S. Cl. CPC G01K 11/06; G01K 11/12; G06K 19/06037

(57) ABSTRACT

A temperature indicator includes a transparent substrate with a first code and a second code disposed on a first side of the transparent substrate. The first code comprises a first color and the second code comprises a second color different than the first color. An absorbent medium is disposed on a second side of the transparent substrate opposite the first side and comprises a third color that contrasts with only the second color of the first and second colors. A substance is disposed between the absorbent medium and the transparent substrate. The substance comprises a fourth color that contrasts with only the first color of the first and second colors and is meltable and absorbed by the absorbent medium in response to a temperature exceeding a temperature threshold.

### PRIORITY INFORMATION

The present application claims priority to U.S. Provisional Application No. 63/341,673 filed on May 13, 2022, and the present application claims priority to U.S. Provisional Application No. 63/449,860 filed on Mar. 3, 2023, each of which is incorporated by reference herein for all purposes.

### TECHNICAL FIELD

The present subject matter relates generally to temperature indicators.

### BACKGROUND

During manufacturing, storage, or transit, many types of objects need to be monitored or tracked due to the temperature sensitivity or fragility of the objects. For example, some types of objects may be susceptible to damage if exposed to certain temperatures (e.g., food or pharmaceutical items). Thus, for quality control purposes and/or the general monitoring of transportation conditions, it is desirable to determine and/or verify the environmental conditions to which the object has been exposed.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic diagram illustrating an application of an exemplary embodiment of a temperature indicator according to the present disclosure;

FIG. 2A is a schematic diagram illustrating a top plan view of an exemplary embodiment of a temperature indicator according to the present disclosure in a non-actuated state;

FIG. 2B is a schematic diagram illustrating a top plan view of an exemplary embodiment of the temperature indicator of FIG. 2A according to the present disclosure in an actuated state;

FIG. 3 is a schematic diagram further illustrating the readability/visibility of codes of an exemplary temperature indicator according to the present disclosure relative to various backgrounds;

FIG. 4 is a schematic, side elevational view of an exemplary embodiment of a temperature indicator according to the present disclosure;

FIG. 5 is a schematic, side elevational view of another exemplary embodiment of a temperature indicator according to the present disclosure;

FIG. 6 is a schematic, side elevational view of another exemplary embodiment of a temperature indicator according to the present disclosure in a non-actuated state; and

FIG. 7 is a schematic, side elevational view of the temperature indicator of FIG. 6 according to the present disclosure in an actuated state.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The following description is provided to enable those skilled in the art to make and use the described embodiments contemplated for carrying out the disclosure. Various modifications, equivalents, variations, and alternatives, however, will remain readily apparent to those skilled in the art. Any and all such modifications, variations, equivalents, and alternatives are intended to fall within the scope of the present disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the disclosure as it is oriented in the figures. However, it is to be understood that the disclosure may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first” and “second” may be used interchangeably to distinguish one component from another and are not intended to signify location or importance of the individual components.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by such term is not to be limited to the precise value specified. In at least some instances, the approximating language may correspond to the precision of an instrument for measuring the value. Here and throughout the specification and claims, range limitations are combined and interchanged. Such ranges are identified and include all the sub-ranges contained therein unless context or language indicates otherwise.

The present disclosure is generally related to a device and technique for temperature detection and indication. According to one embodiment, a temperature indicator includes a first code that is visible/readable in a non-actuated state of the temperature indicator and a second code that is visible/readable in an actuated state of the temperature indicator. Correspondingly, in a non-actuated state of the temperature indicator, the second code on not visible/readable, and in the actuated state of the temperature indicator, the first code is not visible/readable.

The first and second codes each respectively comprise first and second code portions printed on a transparent substrate with a meltable substance disposed on an opposite side of the transparent substrate. The meltable substance is configured to melt in response to being subjected to a temperature exceeding a particular temperature threshold. The meltable substance is disposed in alignment with the first and second code portions and comprises a color forming a background that contrasts with only the first code portion of the first and second code portions such that, prior to melting, the first code is visible/readable while the second code is not visible/readable (i.e., the meltable substance forming a third code portion of the first code such that the first code portion and the third code portion, together, form the first code). Thus, the first code is formed by the first code portion and the third code portion. Beneath the meltable substance is an absorbent medium. The absorbent medium is also disposed in alignment with the first and second code portions and comprises a color forming a background that contrasts with only the first code portion of the first and second code portions (i.e., the absorbent medium forming a fourth code portion of the second code such that the second code portion and the fourth code portion, together, form the second code). Thus, the second code is formed by the second code portion and the fourth code portion such that when the second and fourth code portions are positioned over the background formed by the absorbent medium, the second code is visible/readable while the first code is not visible/readable. Thus, prior to a melting of the meltable substance, the first code is visible/readable (while the second code is invisible/unreadable (or undecipherable by a machine reader)) indicating a non-actuated state of the temperature indicator. Responsive the temperature exceeding the temperature threshold, the meltable substance melts and is absorbed by the absorbent medium such that the background initially provided by the meltable substance is replaced by the background formed by the absorbent medium. Accordingly, with the absorbent medium providing the background to the first and second code portions, the second code becomes visible/readable (while the first code becomes invisible/unreadable), thereby indicating an actuated state of the temperature indicator.

During storage, transit, or use, many types of objects need to be monitored for temperature (i.e., cold chain) of the objects. For example, some types of objects such as food or pharmaceuticals may be susceptible to spoilage or lack of efficacy if they are subjected to temperatures that are too high for too long a time. The duration or threshold of the temperature excursion (i.e., “time-temperature” variable) is often more important than a non-duration focused or real time reading of temperature. Thus, for quality control purposes and/or the general monitoring of transportation/use conditions, it is desirable to determine and/or verify the temperature conditions to which the object has been exposed.

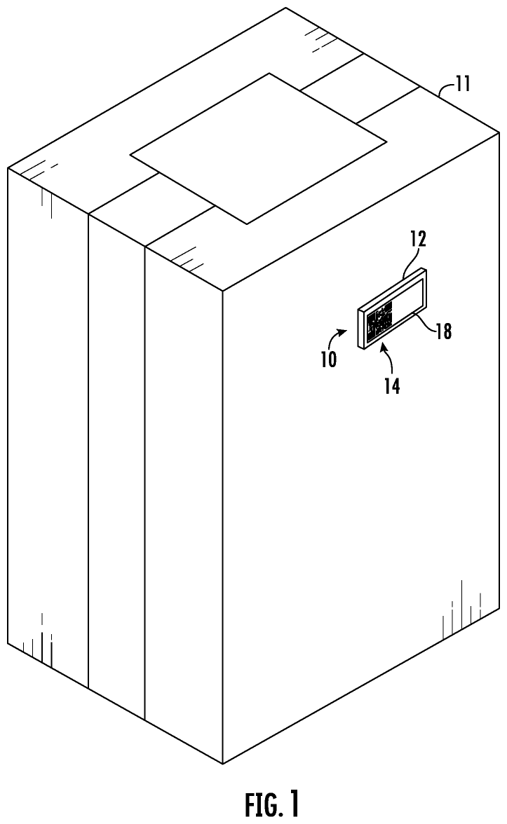

Referring now to the drawings, wherein identical numerals indicate the same elements throughout the figures, specifically FIG. 1, FIG. 1 is an exemplary diagram of a temperature indicator 10 are provided in which illustrative embodiments of the present disclosure may be implemented. FIG. 1 is a diagram illustrating a front view of temperature indicator 10. In FIG. 1, indicator 10 is a portable device configured to be affixed to or disposed within a transport container 11 containing an object (or is the object of interest itself) of which temperature events associated therewith are to be monitored. Embodiments of temperature indicator 10 monitor whether an object has been exposed to a particular temperature or environment during manufacturing, storage and/or transport of the object. In exemplary embodiments, temperature indicator 10 may be affixed to a transport container using, for example, adhesive materials, permanent or temporary fasteners, or a variety of different types of attachment devices. The transport container may include a container in which a monitored object is loosely placed or may comprise a container of the monitored object itself. It should be appreciated that FIG. 1 is only exemplary and is not intended to assert or imply any limitation with regard to the environments in which different embodiments may be implemented.

In the embodiment illustrated in FIG. 1, temperature indicator 10 comprises a housing 12 having a temperature sensing, temperature-sensitive and/or temperature detection assembly 14 disposed therein. In the illustrated embodiment, detection assembly 14 is configured to detect and indicate temperature events relative to indicator 10 (e.g., detecting when indicator 10 (and correspondingly, a container to which indicator 10 is associated with) has been subjected to a particular environmental temperature and/or an environmental temperature for a particular time duration). In exemplary embodiments, housing 12 is configured and/or constructed from a clear or semi-opaque material having a masking label 16 located on a front side thereof or affixed thereto. In exemplary embodiments, masking label 16 is configured having one or more apertures or “windows” 18 for providing a visual indication of temperature detection. For example, in exemplary embodiments, temperature indicator 10 is configured to visually indicate whether the temperature indicator 10 has been subject to a particular temperature event, and such indication is provided within or through one or more of windows 18 to provide a visual indication that the monitored object has or may have been subjected to some level of temperature event. However, it should be understood that other methods may be used to provide a visual indication that detection assembly 14 has been otherwise placed into an actuated state indicating that indicator 10 has experienced some level of temperature event. It should also be understood that housing 12 may be configured and/or manufactured from other materials (e.g., opaque materials having one or more windows 18 formed therein).

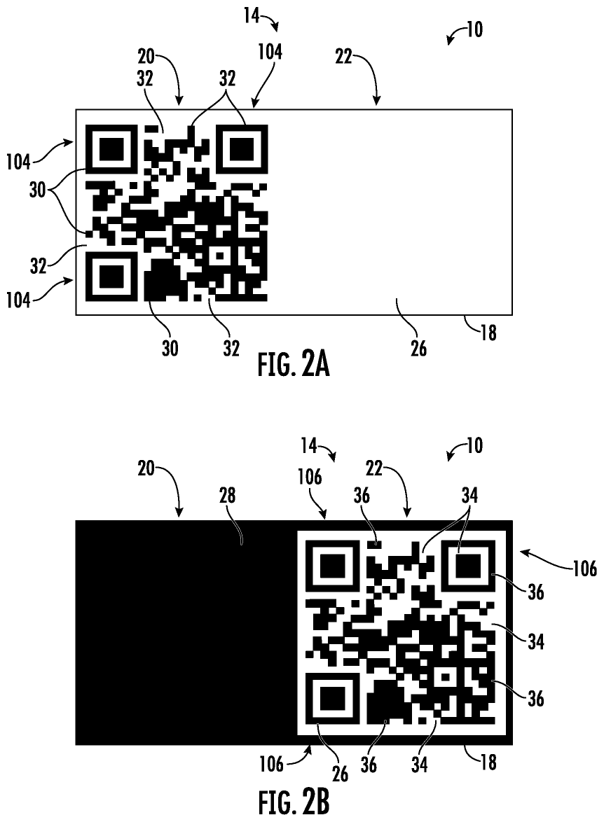

Referring to FIGS. 2A and 2B, FIG. 2A is a schematic top view of an exemplary embodiment of the temperature indicator 10 in accordance with the present disclosure in a non-actuated state, and FIG. 2B is a schematic top view of an exemplary embodiment of the temperature indicator 10 in accordance with the present disclosure in an actuated state. In the illustrated embodiment, the temperature indicator 10 comprises the detection assembly 14 comprising a code 20 and a code 22. In the illustrated embodiment, the codes 20 and 22 comprise quick response (QR) codes 20 and 22 such that the QR codes 20 and 22 are machine-readable. However, it should be understood that codes 20 and 22 may comprise other types of machine-readable codes, such as but not limited to, barcodes, data matrix codes, etc., or may comprise human-readable codes.

For example, QR codes are machine-readable optical images that have high data density, are dirt and damage resistant, and are readable in any direction. Use of QR Codes is standardized in at least ISO Standard ISO/IEC 18004:2015 Information technology—Automatic identification and data capture techniques QR Code bar code symbology specification. Two primary elements of any QR code are the position detection markers and the data module. QR codes typically include squares arranged in a square grid using colors that provide a high level of contrast relative to each other (e.g., the brightness or color contrast is generally binary in nature—either light or dark, for example). Two frequently used colors are black and white such that the QR code typically comprises black squares or dots (sometimes referred to as a black pixel pattern) in combination with white spaces (the white spaces may also be referred to as a white pixel pattern), mainly because of the high brightness contrast between the colors of black and white. The unique pattern of the black and white pixel patterns encodes a string of data.

A data matrix (DM) code is similar to a QR code. A data matrix code is also a two-dimensional code comprising black and white “cells” or dots arranged in either a square or rectangular pattern, also known as a matrix. One difference between a data matrix code and a QR code is in the position detection markers and data encoding method. Unlike QR codes that can be read with a smart phone, for example, a data matrix code is usually read or verified using two-dimensional code readers. The information in the data matrix code to be encoded can be text or numeric data. Usual data size is from a few bytes up to 1556 bytes. The length of the encoded data depends on the number of cells in the matrix. Error correction codes are used to increase reliability: even if one or more cells are damaged so it is unreadable, the message can still be read. A data matrix symbol can store up to 2,335 alphanumeric characters. Data matrix symbols are rectangular, usually square in shape and composed of square “cells” which represent bits. Depending on the coding used, a “light” cell represents a “0” and a “dark” cell represents a “1,” or vice versa. Every data matrix is composed of two solid adjacent borders in an “L” shape (called the “finder pattern”) and two other borders consisting of alternating dark and light “cells” or modules (called the “timing pattern”). Within these borders are rows and columns of cells encoding information. The finder pattern is used to locate and orient the symbol while the timing pattern provides a count of the number of rows and columns in the symbol. As more data is encoded in the symbol, the number of cells (rows and columns) increases.

For ease of description and illustration, an exemplary embodiment of the temperature indicator 10 will be described and illustrated hereafter using QR codes such that the codes 20 and 22 will be referred to hereafter as the QR codes 20 and 22. However, as indicated above, other types of codes may be used in accordance with the present disclosure such as, but not limited to, a DM code, a mQRCode, a rectangular micro QR (rMQR) code, a XIN code, and an Aztec code.

In the illustrated embodiment, the QR codes 20 and 22 are visible via the window 18 formed within the masking label 16 disposed on the housing 12. In FIG. 2A, within the window 18 is a background 26, and in FIG. 2B, within the window 18 is a background 28. In the illustrated embodiment, the color of the background 26 is white, and the color of the background 28 is black. In FIGS. 2A and 2B, the QR code 20 comprises a first code portion in the form of a first pixel pattern 30 and a second code portion in the form of a second pixel pattern 32. The color for the first pixel pattern 30 contrasts with the underlying background 26. For example, in the illustrated embodiment, the color of the first pixel pattern 30 forming the QR code 20 is black, and the background 26 forms or provides the second pixel pattern 32. As will be described in greater detail below, the first pixel pattern 30 is printed or applied onto a transparent substrate which is disposed over the backgrounds 26 and 28. Thus, in the illustrated embodiment, only the first pixel pattern 30 of the QR code 20 is printed or applied onto the transparent substrate such that the underlying white background 26 provides the second pixel pattern 32 (i.e., the white dots forming the white spaces of the QR code 20) of the QR code 20.

The QR code 22 comprises a third code portion in the form of a third pixel pattern 34 and a fourth code portion in the form of a fourth pixel pattern 36. The color for the third pixel pattern 34 contrasts with the underlying background 26. For example, in the illustrated embodiment, the color of the third pixel pattern 34 forming the QR code 22 is white, and the background 28 forms or provides the fourth pixel pattern 36. As will be described in greater detail below, the third pixel pattern 34 is printed or applied onto the transparent substrate which is disposed over the backgrounds 26 and 28. Thus, in the illustrated embodiment, only the third pixel pattern 34 of the QR code 22 is printed or applied onto the transparent substrate such that the underlying black background 28 provides the fourth pixel pattern 36 (i.e., the black dots between the white spaces of the QR code 22) of the QR code 22. Thus, the third pixel pattern 34 is also printed or applied onto the transparent substrate but is formed as a negative image such that the black-and-white pixel patterns of the QR code 22 are reversed. That is, the QR code 22 is created such that the white third pixel pattern 34 is printed or applied onto the transparent substrate such that a black background, such as the black background 28, provides the black fourth pixel pattern 36 of the QR code 22. In the illustrated embodiment, the QR codes 20 and 22 are disposed in spaced apart relationship to each other, and the first and third pixel patterns 30 and 34 are both printed or applied onto the same side of the transparent substrate. Thus, in FIG. 2A, although both of the pixel patterns 30 and 34 are present, because of the white background 26, only the QR code 20 is visible/readable because of a lack of color contrast between the white background 26 and the white third pixel pattern 34 of the QR code 22. Accordingly, in FIG. 2B, although both of the pixel patterns 30 and 34 are present on the transparent substrate, because of the black background 28, only the QR code 22 is visible/readable because of a lack of color contrast between the black background 28 and the black first pixel pattern 30 of the QR code 20. In exemplary embodiments, the pixel patterns 30 and 34 are present and remain present in their original forms on the transparent substrate in a non-actuated and actuated state of the temperature indicator 10. As will be described in greater detail below, the detection assembly 14 of the temperature indicator 10 is configured such that the temperature indicator 10 transitions from the background 26 to the background 28 in response to the temperature indicator 10 being subjected to a temperature event exceeding a particular threshold. Thus, in FIGS. 2A and 2B, the QR code 20 represents data indicative of a non-actuated state of the temperature indicator 10, and the QR code 22 represents data indicative of an actuated state of the temperature indicator 10.

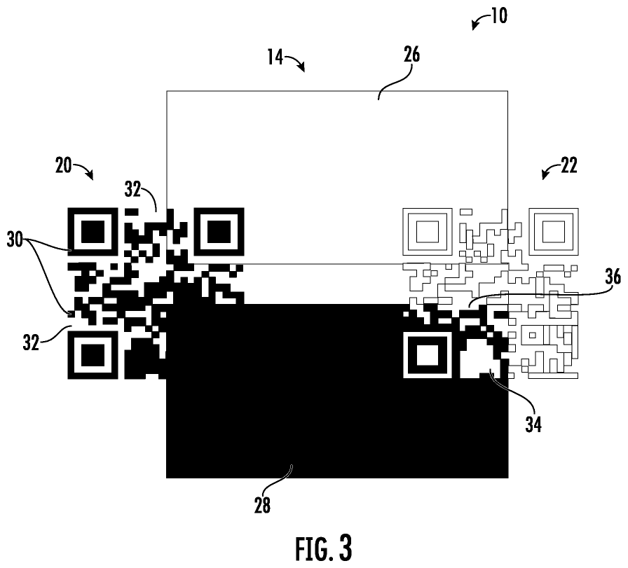

FIG. 3 is a schematic diagram further illustrating the readability/visibility of the QR codes 20 and 22 when disposed over the backgrounds 26 and 28 according to the present disclosure. Similar to as described above, the first pixel pattern 30 of the QR code 20 is printed or applied onto the transparent substrate and comprises a black first pixel pattern 30 for the QR code 20 such that the white background 26 provides the white second pixel pattern 32 forming the white spaces of the QR code 20, and together forming the QR code 20. As illustrated in FIG. 3, the QR code 20 is readable/visible when the white background 26 is beneath the black first pixel pattern 30 but is not readable/visible when the black background 28 is beneath the black first pixel pattern 30. The third pixel pattern 34 of the QR code 22 is printed or applied onto the transparent substrate and comprises a white third pixel pattern 34 such that the black background 28 provides the black fourth pixel pattern 36 (forming the black squares/dots of the QR code 22), and together forming the QR code 22. As illustrated in FIG. 3, the QR code 22 is readable/visible when the white third pixel pattern 34 disposed over the black background 28 but is not readable/visible when the white third pixel pattern 34 is disposed over the white background 26.

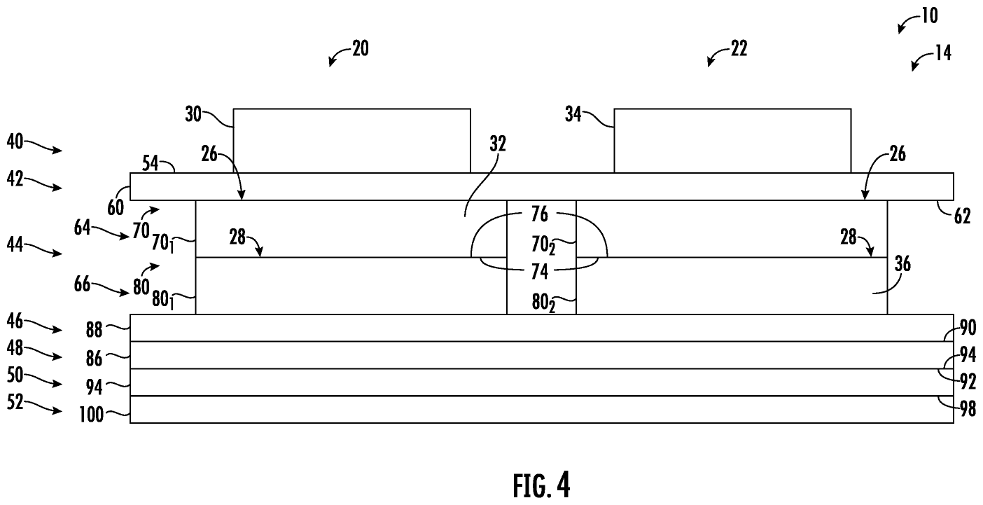

FIG. 4 is a schematic, side elevational view of the exemplary embodiment of the temperature indicator 10 of FIGS. 1-3 according to the present disclosure. For ease of description and illustration, various components of the temperature indicator 10 are not depicted in FIG. 4 (e.g., the housing 12 (FIG. 1)). In the illustrated embodiment, the temperature indicator 10 comprises, among additional components, the detection assembly 14, in a stacked or layered arrangement, a code layer 40, a substrate layer 42, a background layer 44, an adhesive layer 46, a carrier layer 48, an adhesive layer 50, and a release layer 52. In the illustrated embodiment, the code layer 40 comprises the first and third pixel patterns 30 and 34 forming the respective QR codes 20 and 22. The first and third pixel patterns 30 and 34 are disposed or printed on a top side 54 of the substrate layer 42 in spaced apart relationship to each other. However, it should be understood that the QR codes 20 and 22 may abut each other. As described above, the QR code 20 comprises the black first pixel pattern 30 printed or applied to the top side 54 of the substrate layer 42, and the QR code 22 comprises the white third pixel pattern 34 printed or applied to the top side 54 of the substrate layer 42. Thus, in FIG. 4, the first and third pixel patterns 30 and 34 of the respective QR codes 20 and 22 face upwardly and are disposed in a viewing direction of the temperature indicator 10.

In exemplary embodiments, the substrate layer 42 comprises a substrate 60 enabling light to pass therethrough such that the background layer 44 disposed adjacent a bottom side 62 of the substrate layer 42 is visible when viewed from a direction corresponding to the top side 54 of the substrate layer 42. In exemplary embodiments, the substrate 60 comprises a transparent substrate 60 such that the background layer 44 is readily visible through the substrate 60 when viewed from a direction corresponding to the top side 54 of the substrate layer 42.

In exemplary embodiments, the background layer 44 is disposed adjacent the bottom side 62 of the substrate layer 42 and comprises a melt layer 64 and an absorbent layer 66. The melt layer 64 comprises a substance 70 configured or selected to melt when a temperature experienced by the temperature indicator 10 exceeds a particular temperature threshold. For example, in exemplary embodiments, the substance 70 comprises a wax material selected to melt upon the wax material being exposed to a temperature exceeding a particular temperature threshold. In exemplary embodiments, the wax material may comprise lipids available commercially from Sigma Aldrich under the product designation of stearic acid. In the illustrated embodiment, the substance 70 comprises a white substance or a white wax material forming a white melt layer 64 and thereby forming the white background 26 (FIGS. 2A and 3). In the illustrated embodiment, a top side 72 of the melt layer 64 is disposed adjacent the bottom side 62 of the substrate layer 42, and a bottom side 74 of the melt layer 64 is disposed adjacent a top side 76 of the absorbent layer 66.

The absorbent layer 66 comprises an absorbent medium 80 configured to absorb the substance 70 in response to a melting of the substance 70. In exemplary embodiments, the absorbent medium 80 comprises a black absorbent medium 80 forming a black absorbent layer 66 and thereby forming the black background 28 (FIGS. 2B and 3). In exemplary embodiments, the absorbent medium 80 comprises one or more plies or sheets of black kraft paper available commercially from Delta Paper under the product name Black Kraft Paper.

In the embodiment illustrated in FIG. 4, the substance 70 forming the melt layer 64 comprises a substance 70₁ disposed in vertical alignment with the first pixel pattern 30 and a substance 70₂ disposed in vertical alignment with the third pixel pattern 34 such that the substances 70₁ and 70₂ are disposed in a spaced apart relationship to each other. However, it should be understood that the melt layer 64 may be formed such that the substance 70 extends horizontally in a continuous manner to be disposed in vertical alignment with both of the first and third pixel patterns 30 and 34. Similarly, in the embodiment illustrated in FIG. 4, the absorbent medium 80 forming the absorbent layer 66 comprises an absorbent medium 80₁ disposed in vertical alignment with the first pixel pattern 30 and an absorbent medium 80₂ disposed in vertical alignment with the third pixel pattern 34 such that the absorbent mediums 80₁ and 80₂ are disposed in a spaced apart relationship to each other. However, it should be understood that the absorbent layer 66 may be formed such that the absorbent medium 80 extends horizontally in a continuous manner to be disposed in vertical alignment with both of the first and third pixel patterns 30 and 34.

Disposed adjacent a bottom side 82 of the absorbent layer 66 is the adhesive layer 46, and disposed adjacent the adhesive layer 46 is the carrier layer 48. In exemplary embodiments, the adhesive layer 46 and the carrier layer 48 may comprise a unitary structure or component such that the adhesive layer 46 and the carrier layer 48 comprise a self-adhesive transfer film. For example, in exemplary embodiments, the carrier layer 48 comprises a single sided adhesive carrier material 86 with an adhesive 88 on a top side 90 of the carrier material 86. The adhesive 88 is disposed in contact with and is adhered to the absorbent medium 80 to thereby secure the absorbent medium 80 in a particular position. Disposed on a bottom side 92 of the carrier material 86 is the adhesive layer 50. The adhesive layer 50 may comprise double-sided self-adhesive film 94 such that a top side 96 of the film 94 is adhered to the carrier material 86 and a bottom side 98 of the film 94 is adhered to the release layer 52. The release layer 52 may comprise a removable liner 100 that may be removed from the temperature indicator 10 to thereby expose the bottom side 98 of the film 94 to enable the bottom side 98 of the film 94 to be adhered to an object (e.g., the transport container 11 (FIG. 1).

In operation, in a non-actuated state of the temperature indicator 10, the substance 70 is in a solid form (not yet melted) and forms the background 26 beneath the substrate 60. As described above, in exemplary embodiments, the substance 70 comprises a white substance 70 such that the substance 70 is a color that contrasts with only the first pixel pattern 30 (i.e., a black pixel pattern 30) of the first and third pixel patterns 30 and 34 (the third pixel pattern 34 being a white pixel pattern 34). Thus, in a non-actuated state of the temperature indicator 10, the substance 70 forming the melt layer 64 is a color that contrasts with a color of the first pixel pattern 30 but does not contrast with a color of the third pixel pattern 34. Accordingly, in a non-actuated state of the temperature indicator 10, the QR code 20 is visible/readable because of the contrasting colors of the black first pixel pattern 30 and the white background 26 formed by the white substance 70, while the QR code 22 is not visible/readable due to the lack of color contrast between the white third pixel pattern 34 and the white background 26 formed by the white substance 70 (as depicted in FIG. 2A).

In response to the temperature indicator 10 being subjected to a temperature exceeding a particular temperature threshold, the substance 70 melts and is absorbed by the absorbent medium 80 such that the white substance 70 no longer provides a contrasting color to the first and third pixel patterns 30 and 34. Accordingly, the background viewable behind the first and third pixel patterns 30 and 34 transitions from the background 26 (white) to the background 28 (black). As described above, in exemplary embodiments, the absorbent medium 80 comprises a black absorbent medium 80 such that the absorbent medium 80 is a color that contrasts with only the third pixel pattern 34 (i.e., a white pixel pattern 34) of the first and third pixel patterns 30 and 34 (the first pixel pattern 30 being a black pixel pattern 30). Thus, in an actuated state of the temperature indicator 10, the absorbent medium 80 forming the absorbent layer 66 is a color that contrasts with a color of the third pixel pattern 34 but does not contrast with a color of the first pixel pattern 30. Accordingly, in an actuated state of the temperature indicator 10, the QR code 22 is visible/readable because of the contrasting colors of the white third pixel pattern 34 and the black background 28 formed by the black absorbent medium 80, while the QR code 20 is not visible/readable due to the lack of color contrast between the black first pixel pattern 30 and the black background 28 formed by the black absorbent medium 80 (as depicted in FIG. 2B). In exemplary embodiments, the substance 70₁ and the substance 70₂ may be configured or selected to melt at slightly different temperature thresholds such that transitions from the white background 26 to the black background 28 occur at slightly staggered times so that at least one of the QR codes 20 and 22 is always visible/readable.

In the exemplary embodiment of the temperature indicator 10 described and depicted above, the melt layer 64 and absorbent layer 66 are disposed in alignment with an entirety of the first and third pixel patterns 30 and 34 such that, depending on the background 26 or 28 currently visible beneath the first and third pixel patterns 30 and 34, the entirety of the QR code 20 or 22 is visible/readable or invisible/unreadable. However, it should be understood that in other exemplary embodiments, the meltable substance 70 and the absorbent medium 80 may be locally positioned such that only a portion of the QR codes 20 and 22 are affected by the melting of the meltable substance 70. For example, in this embodiment, referring to FIGS. 2A, 2B, and 4, the melt layer 64 may comprise a solid white unmeltable component (e.g., a white plastic strip) disposed in vertical alignment with a first portion of the first pixel pattern 30 while the meltable substance 70₁ and the absorbent material 80₁ are vertically aligned with a second portion first pixel pattern 30. For example, in this embodiment, the meltable substance 70₁ and the absorbent material 80₁ are vertically aligned with one or more position detection markers 104 of the first pixel pattern 30 such that, in response to a melting of the meltable substance 70₁, one or more of the position detection markers 104 become invisible/unreadable, thereby resulting in the QR code 20 being unreadable by a reader. Similarly, the melt layer 64 may comprise a solid black unmeltable component (e.g., a black plastic strip) disposed in vertical alignment with a first portion of the third pixel pattern 34 while the meltable substance 70₂ and the absorbent material 80₂ are vertically aligned with a second portion third pixel pattern 34. For example, in this embodiment, the meltable substance 70₂ and the absorbent material 80₂ are vertically aligned one or more position detection markers 106 of the third pixel pattern 34 such that, in a non-actuated state, the one or more position detection markers 106 are unreadable, but in response a melting of the meltable substance 70₂, one or more of the position detection markers 106 become readable, thereby resulting in the QR code 22 being readable by a reader. Thus, it should be understood that, based on the type of code 20 and/or 22 used, portions of the temperature indicator 10 configured to change colors can be selectively located corresponding to certain portion(s) of the code 20 and/or 22 to enable or impair the readability of the code 20 and/or 22.

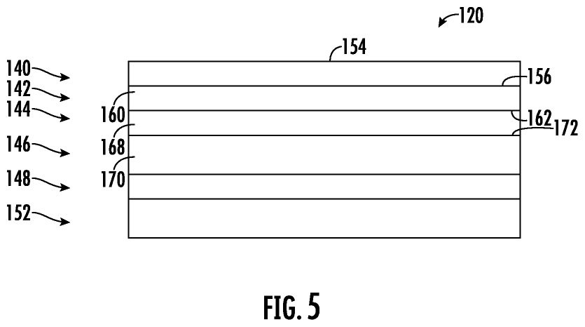

FIG. 5 is a schematic, side elevational view of another exemplary embodiment of a temperature indicator 120 according to the present disclosure. For ease of description and illustration, various components of the temperature indicator 120 may be similar to the components of the temperature indicator 10 of FIGS. 1-4 and are not depicted in FIG. 5 (e.g., the housing 12 (FIG. 1)). In the illustrated embodiment, the temperature indicator 120 comprises, in a stacked or layered arrangement, a code layer 140, a substrate layer 142, a background layer 144, a substrate layer 146, an adhesive layer 148, and a release layer 152. In the illustrated embodiment, the code layer 140 comprises a code 154 printed or applied to a top side 156 of the substrate layer 142. The code 154 may be any type of code, such as, but not limited to, a barcode, QR code, data matrix code, or other types of machine-readable or human-readable codes. In exemplary embodiments, the code 154 comprises a first color C1. The code 154 faces upwardly and is disposed in a viewing direction of the temperature indicator 120.

In exemplary embodiments, the substrate layer 142 comprises a substrate 160 enabling light to pass therethrough such that the background layer 144 disposed adjacent a bottom side 162 of the substrate layer 142 is visible when viewed from a direction corresponding to the top side 156 of the substrate layer 142. In exemplary embodiments, the substrate 160 comprises a transparent substrate 160 such that the background layer 144 is readily visible through the substrate 160 when viewed from a direction corresponding to the top side 156 of the substrate layer 142. Thus, in exemplary embodiments, the code 154 is printed or applied onto the substrate 160.

In exemplary embodiments, the background layer 144 is disposed adjacent the bottom side 162 of the substrate layer 142 and comprises a thermochromic substance 168 that undergoes a change or transitions from a second color C2 to a third color C3 when exposed to a temperature threshold. For example, in exemplary embodiments, the thermochromic substance 168 may comprise a thermochromic ink. The thermochromic substance 168 may comprise a binder and a micro-encapsulated leuco dye-based composition. The binder can be chosen in a variety of chemical compositions such as, but not limited to, polyacrylic, polyurethane, and polyamide. One example of such a composition is the combination of 3,3-bis(4-dimethylaminophenyl)-6-dimethylaminophthalide with a color developer such as Bisphenol A and a temperature sensitive reaction medium which is microencapsulated to form 1-10 microns diameter almost spherical shaped microcapsules. The temperature sensitive color change composition is typically selected to have a phase change temperature at or near the desired temperature threshold of the temperature indicator 120. A typical micro-encapsulated leuco dye-based composition is commercially available from SpotSee of Dallas, TX under the trade name “Cold Activated Graphics.”

The substrate layer 146 may comprise a substrate 170. The substrate 170 may comprise a polyethylene single-sided adhesive tape with a print receptive coating on a top side 172 thereof. The thermochromic substance 168 can be applied to the top side 172 of the substrate 170 using application methods such as, but not limited to, printing (example gravure, offset, flexographic, silk screen, etc.), rollers, meter bar coating, knife coating or sliding bars. The adhesive layer 148 and the release layer 152 may be formed similar to the adhesive layer 50 and the release layer 152, respectively, of the temperature indicator 10 (FIG. 4).

In exemplary embodiments, the color C1 of the code 154 contrasts with the color C2 of the thermochromic substance 168 such that, prior to being exposed to a temperature threshold that would cause a color change of the thermochromic substance 168 from the color C2 to the color C3, the code 154 is visible/readable over the background color provided via the color C2 of the thermochromic substance 168. In exemplary embodiments, the third color C3 of the thermochromic substance 168 is identical or similar to the color C1 of the code 154. Thus, in response to the temperature indicator 120 being exposed to the temperature threshold causing a color change of the thermochromic substance 168, the thermochromic substance 168 changes or transitions from the color C2 to the color C3 resulting in a lack or color contrast between the color C3 and the color C1 of the code 154 and thereby rendering the code 154 invisible/unreadable. Thus, in a non-actuated state, the code 154 may be visible/readable, and in an actuated state, the code 154 is not visible/readable.

In exemplary embodiments, at temperature above the temperature threshold that would cause a color change of the thermochromic substance 168, leuco dye compositions-based ink are transparent white (or substantially transparent), but as the temperature is decreased, the color former and color developer combine chemically. The resulting combination absorbs a significant amount of light energy in the visible light spectrum, resulting in significant darkening of the (typically transparent white) of the substance. The resultant brightness/color change of the background (i.e., the thermochromic substance 168) results in a change in the machine-readable information of the code 154. For example, in exemplary embodiments, the code 154 may comprise a black pixel pattern (similar to the first pixel pattern 30 (FIGS. 2A and 3)), and the background formed by the background layer 144 (i.e., formed by the thermochromic substance 168) would be white, thereby forming a white pixel pattern for the code 154 (similar to the second pixel pattern 32 forming the background 26 (FIGS. 2A and 3)). Thus, in a non-actuated state of the temperature indicator 120, the code 154 would appear similar to the code 20 (FIGS. 2A and 3). In response to a decrease in temperature to or below the temperature threshold for the thermochromic substance 168, the thermochromic substance 168 changes to a dark color, such as black, such that the background formed by the background layer 144 (i.e., formed by the thermochromic substance 168) would be black, thereby resulting in the code 154 being invisible/unreadable (similar to the code 20 depicted in FIG. 2B). Similar to as described above in connection with the temperature indicator 10 (FIGS. 1-4), the thermochromic substance 168 may be locally positioned to affect the viewability/readability of a portion of the code 154 (e.g., in alignment with position detection marker(s) of a QR code or select portion of other types of codes) such that at least a portion of the code 154 may remain viewable but not be machine-readable.

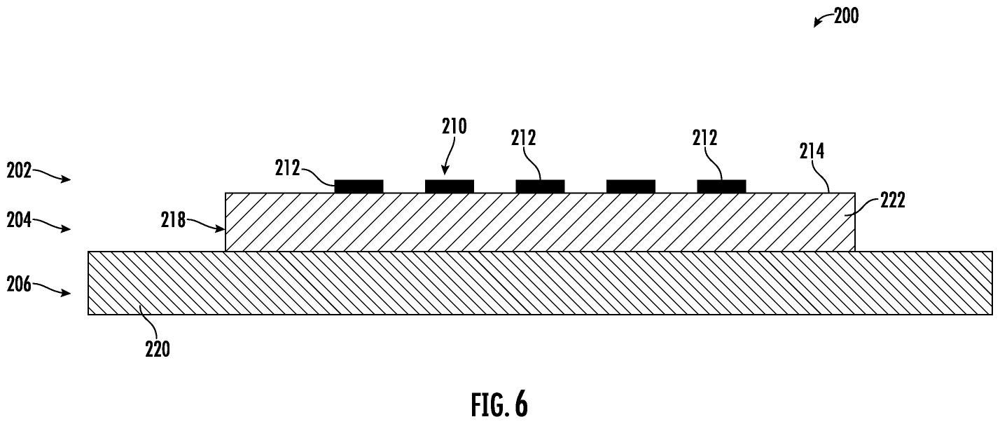

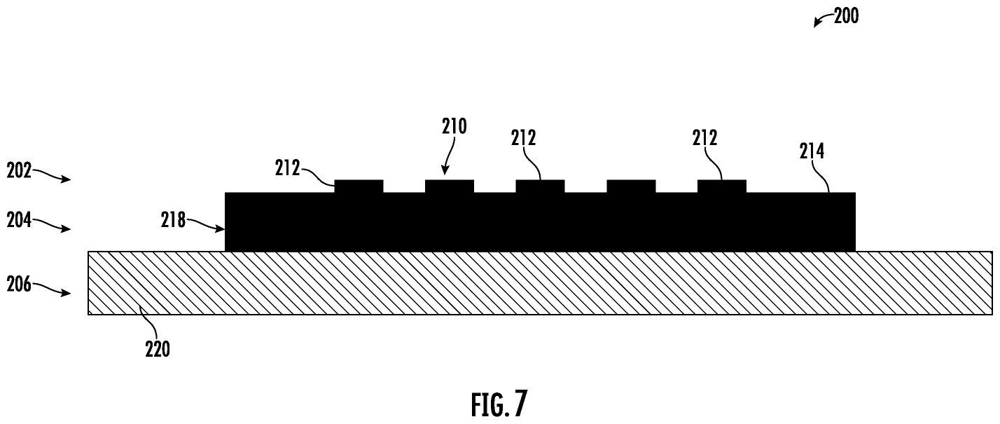

Referring to FIGS. 6 and 7, FIG. 6 is a schematic, side elevational view of another exemplary embodiment of a temperature indicator 200 according to the present disclosure in a non-actuated state, and FIG. 7 is a schematic, side elevational view of the temperature indicator 200 of FIG. 6 according to the present disclosure in an actuated state. For ease of description and illustration, various components of the temperature indicator 200 may be similar to the components of the temperature indicator 10 of FIGS. 1-4 and the temperature indicator 120 of FIG. 5 but are not depicted in FIGS. 6 and 7 (e.g., the housing 12 (FIG. 1)). In the illustrated embodiment, the temperature indicator 200 comprises, in a stacked or layered arrangement, a code layer 202, a compound layer 204, and a substrate layer 206. In the illustrated embodiment, the temperature indicator 200 provides a visual indication of an actuation status of the temperature indicator 200 based on the viewability/readability of a code 210. For example, as will be described in greater detail below, in exemplary embodiments, the code 210 may be formed based on a color and/or a transparency, or a variation thereof in response to a temperature event, of one or more layers (e.g., the layers 202, 204, and/or 206) of the temperature indicator 200.

In the illustrated embodiment, the code layer 202 comprises at least a portion 212 of the code 210 printed or applied to a top side 214 of the compound layer 204 and facing upwardly in a viewing direction of the temperature indicator so as to be viewable by an end user of the temperature indicator 200. As described above, the code 210 may comprise any type of human- and/or machine-readable code such that, in response to a temperature event, the temperature indicator 200 undergoes a change or transition affecting the viewability/readability of the code 210. The portion 212 of the code 210 may be printed onto the top side 214 of the compound layer 204 using a variety of methods such as, but not limited to, ink from an inkjet or laser printer (not shown). In exemplary embodiments, the portion 212 of the code 210 comprises a dark color such as, but not limited to, black. For example, in exemplary embodiments, the portion 212 of the code 210 may comprise a black ink printed or applied onto the top side 214 of the compound layer 204 such that the portion 212 forms a black pixel pattern (e.g., similar to the first pixel pattern 30 (FIGS. 2A and 3)) of the code 210.

In exemplary embodiments, the compound layer 204 comprises a thermochromic substance 218 that undergoes a color or transparency change when exposed to a temperature threshold or temperature event. For example, in exemplary embodiments, the thermochromic substance 218 may comprise or be similar to the thermochromic substance 168 (FIG. 5) and may comprise a thermochromic ink. Similar to as described above for the thermochromic substance 168 (FIG. 5), the thermochromic substance 218 may comprise a binder and a micro-encapsulated leuco dye-based composition. The binder can be chosen in a variety of chemical compositions such as, but not limited to, polyacrylic, polyurethane, and polyamide. One example of such a composition is the combination of 3,3-bis(4-dimethylaminophenyl)-6-dimethylaminophthalide with a color developer such as Bisphenol A and a temperature sensitive reaction medium which is microencapsulated to form 1-10 microns diameter almost spherical shaped microcapsules. The temperature sensitive color change composition is typically selected to have a phase change temperature at or near the desired temperature threshold of the temperature indicator 200.

In the illustrated embodiment, the substrate layer 206 comprises a substrate 220. In exemplary embodiments, the substrate 220 comprises a medium having a color that contrasts with the color of the portion 212 of the code 210 such that the substrate 220 forms at least another portion 222 of the code 210. For example, in exemplary embodiments, the substrate 220 may comprises a white (or other contrasting color relative to the color of the portion 212) paper label (or other type of material) such that the substrate 220 forms the white pixel pattern of the code 210 (e.g., similar to the second pixel pattern 32 (FIGS. 2A and 3)). As will be described further below, because of the transparent nature of the thermochromic substance 218 above a temperature threshold, the substrate 220 is visible through the thermochromic substance 218 (in a non-actuated state of the temperature indicator 200) such that the substrate 220 forms the portion 222 of the code 210 (similar to the background 26 of the temperature indictor 10 (FIGS. 2A and 3)).

Similar to as described above in connection with the thermochromic substance 168 of the temperature indicator 120 (FIG. 5), in exemplary embodiments, at a temperature above the temperature threshold that would cause a color change of the thermochromic substance 218, leuco dye compositions-based ink are transparent white, but as the temperature is decreased, the color former and color developer combine chemically. The resulting combination absorbs a significant amount of light energy in the visible light spectrum, resulting in significant darkening of the (typically transparent white) substance. The resultant brightness/color change of the thermochromic substance 218 results in a change in the viewability/readability of the code 210. For example, in a non-actuated state of the temperature indicator 200, the code 210 would be visible/readable (e.g., similar to the code 20 (FIGS. 2A and 3). In response to a decrease in temperature to or below the temperature threshold for the thermochromic substance 218, the thermochromic substance 218 changes to a color lacking in contrast to the color of the portion 212 (e.g., a dark color, such as black) such that the color change of the thermochromic substance 218 impairs the viewability/readability of the portion 212, and thereby the overall viewability/readability of the code 210. As depicted in FIG. 7, in the illustrated embodiment, in response to a decrease in temperature to or below the temperature threshold for the thermochromic substance 218, the thermochromic substance 218 changes to black (e.g., a same color as the color of the portion 212) such that a lack of color contrast between the thermochromic substance 218 and the portion 212 impair the viewability/readability of the code 210. For example, in an actuated state, the color change or transition of the thermochromic substance 218 causes the thermochromic substance 218 to become similar to the background 28 of the temperature indicator 10 (FIGS. 2B and 3) such that the code 210 is no longer viewable/readable. Thus, in an actuated state, the decrease in temperature to or below the temperature threshold for the thermochromic substance 218 causes a change in the level of transparency of the thermochromic substance 218 such that the substrate 220 is no longer visible through the thermochromic substance 218 (or its visibility through the thermochromic substance 218 is significantly decreased or impaired).

Thus, embodiments of the present disclosure provide a temperature indicator that provides visual and/or non-visual indications of temperature excursions beyond a temperature threshold. Embodiments of the present disclosure use various methods and/or materials to use and/or create color contrasts between various components or layers of the temperature indicator to indicate an actuation state of the temperature indicator. In exemplary embodiments, a particular actuation code (depicting either a non-actuated or actuated state) of the temperature indicator is formed from at least two components or layers, and at least one of the components or layers undergoes a change in color to thereby affect or impair the viewability or readability of the actuation code.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

While this disclosure has been described as having exemplary designs, the present disclosure can be further modified within the scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A temperature indicator, comprising:
a transparent substrate;
a first portion of a first code and a second portion of a second code disposed on a first side of the transparent substrate, the first portion comprising a first color, the second portion comprising a second color different than the first color;
an absorbent medium disposed on a second side of the transparent substrate opposite the first side, the absorbent medium comprising a third color that contrasts with only the second color of the first and second colors; and
a substance disposed between the absorbent medium and the transparent substrate, the substance comprising a fourth color that contrasts with only the first color of the first and second colors, the substance meltable and absorbed by the absorbent medium in response to a temperature exceeding a temperature threshold.

2. The temperature indicator of claim 1, wherein the first code and the second code comprise a respective first quick response (QR) code and a second QR code.

3. The temperature indicator of claim 1, wherein, responsive to the substance being absorbed by the absorbent medium, the first code is unreadable.

4. The temperature indicator of claim 1, wherein, prior to the substance being absorbed by the absorbent medium, the second code is unreadable.

5. The temperature indicator of claim 2, wherein the substance is disposed in alignment with at least one of a position detection marker of the first QR code.

6. The temperature indicator of claim 1, wherein the first code is spaced apart from the second code.

7. The temperature indicator of claim 1, wherein the first code represents a non-actuated state of the temperature indicator and the second code represents an actuated state of the temperature indicator.

8. A temperature indicator, comprising:
a code layer comprising at least a first portion of a code, the code representing a non-actuated state of the temperature indicator;
a substrate layer; and
a compound layer disposed between the code layer and the substrate layer, the compound layer comprising a substance responsive to a temperature change and, responsive to the temperature indicator being exposed to a temperature threshold, the substance changes to a color impairing readability of the code.

9. The temperature indicator of claim 8, wherein the substance comprises a thermochromic substance.

10. The temperature indicator of claim 8, wherein the first portion of the code is applied to a top side of the compound layer.

11. The temperature indicator of claim 8, wherein the substrate layer forms at least a second portion of the code.

12. The temperature indicator of claim 8, wherein, in a non-actuated state, the substrate layer is visible through the compound layer.

13. The temperature indicator of claim 8, wherein the first portion of the code comprises a first color, and wherein the substance changes to a second color lacking contrast to the first color.

14. The temperature indicator of claim 8, wherein the compound layer is substantially transparent in the non-actuated state.

15. A temperature indicator, comprising:
a substrate having a first side and second side opposite the first side;
a first portion of a code disposed on the first side of the substrate, the first portion comprising a first color; and
a substance disposed on the second side of the substrate, the substance comprising a second color contrasting with the first color and forming a second portion of the code at a first temperature, and wherein responsive to the substance being exposed to a second temperature meeting a temperature threshold of the substance, the substance changes from the second color to a third color, the third color impairing readability of the code.

16. The temperature indicator of claim 15, wherein the substance comprises a thermochromic substance.

17. The temperature indicator of claim 15, wherein the code comprises a quick response (QR) code.

18. The temperature indicator of claim 17, wherein the substance is disposed in alignment with at least one of a position detection marker of the QR code.

19. The temperature indicator of claim 15, wherein the third color matches the first color.

20. The temperature indicator of claim 15, wherein the substrate comprises a transparent substrate.
